(19) United States
(12) Patent Application Publication
(10) Pub. No.: US 2007/0284990 A1
(43) Pub. Date: Dec. 13, 2007

(54) Wireless-emitting major-and-minor models recording method

(75) Inventor: Kuo Chih Wu, Yunlin Hsien (TW)

Correspondence Address: TROXELL LAW OFFICE PLLC, SUITE 1404, 5205 LEESBURG PIKE, FALLS CHURCH, VA, 22041, US

(73) Assignee: U Colour International Co., Ltd.

(21) Appl. No.: 11/449,680

(22) Filed: Jun. 9, 2006

(51) Int. Cl. H01J 29/10

(52) U.S. Cl. 313/461

(57) ABSTRACT

A wireless-emitting major-and-minor models recording method comprises major and minor units wherein the major and minor units are respectively equipped with a control circuit panel built therein, and the control circuit panel of the major unit is equipped with an emitting device to reciprocally correspond to a receiving device and a recording device built in the control circuit panel of the minor unit. Via the aforementioned structure thereof, the major and minor units are correspondingly matched to each other to form a wireless emitting-and-receiving system and provide a synchronized wireless digital recording function without being influenced by the surrounding environment, achieving the best sound-receiving effect and recording quality thereby.

### BACKGROUND OF THE INVENTION

The present invention relates to a wireless-emitting major-and-minor models recording method comprises major and minor units wherein the major and minor units are respectively equipped with a control circuit panel built therein to form a wireless emitting-and-receiving system so that the sound emitted can be clearly received without being influenced by the surroundings; besides, the minor unit also includes a recording device so that the sound received can also be synchronically recorded to form a synchronized wireless digital recording effect, ensuring a high quality of recording thereby.

Conventionally, MP3 is equipped with the function of single-item recording. To record the content of a class, the MP3 must be placed closely around the teacher to receive and record the teacher's speech thereby. However, the quality of the recording tends to be determined and influenced by the volume of the sound emitted and the surroundings of recording thereof. Thus, in review, the student can be easily bothered by the poor recording quality with the sound alternating with sudden high/low volume or mixed with noises from the surroundings.

### SUMMARY OF THE PRESENT INVENTION

It is, therefore, the primary purpose of the present invention to provide a wireless-emitting major-and-minor models recording method comprises major and minor units wherein the major and minor units are respectively equipped with an emitting device and a receiving device to form a wireless emitting-and-receiving system so that, within the permissible operating range, the emitting device and the receiving device will reciprocally correspond to each other without being influenced by the surroundings of the recording to achieve the best state of application thereby.

It is, therefore, the second purpose of the present invention to provide a wireless-emitting major-and-minor models recording method wherein the minor unit can also has a recording device built therein, and, via the wireless system of the emitting device and receiving device thereof, the recording device can also provide a synchronized wireless digital recording function, achieving better recording quality thereby.

### BRIEF DESCRIPTION OF THE DRAWINGS

FIG. 1 is a perspective view of the present invention.

FIG. 2 is a diagram showing the present invention in application thereof.

### DETAILED DESCRIPTION OF THE PREFERRED EMBODIMENTS

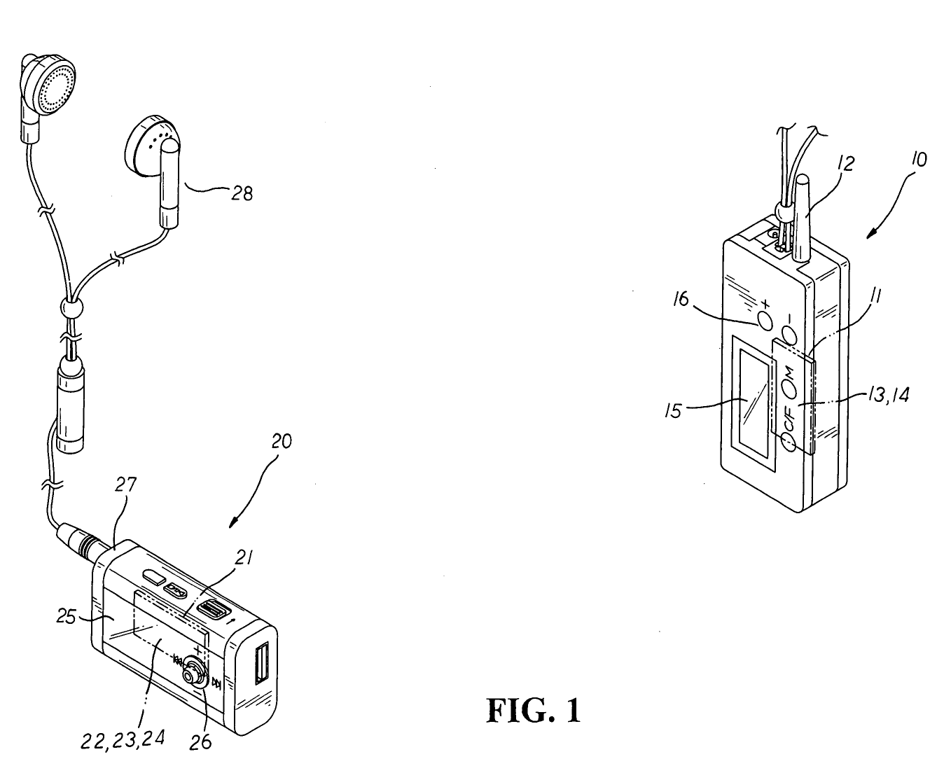

Please refer to FIG. 1 showing a perspective view of the present invention. The present invention relates to a wireless-emitting major-and-minor models recording method, comprising a major unit 10, and a minor unit 20 wherein the major unit 10 has a control circuit panel 11 built therein, and the control circuit panel 11 is equipped with an emitting device 12, a voice-receiving device 13, and a frequency-storing device 14. The external surface of the major model 10 is disposed a display panel 15 and multiple control regulating buttons 16 respectively connected to the control circuit panel 11 thereof. The minor unit 20 also has a control circuit panel 21 built therein, and the control circuit panel 11 is equipped with a receiving device 22, a recording device 23, and a frequency-storing device 24. The external surface of the minor unit 20 is disposed a display panel 25, multiple control regulating buttons 26 and an earphone port 27 respectively connected to the control circuit panel 21 thereof. And, a set of earphones 28 is provided to fit to the earphone port 27 thereby. Via the characteristics of frequency modulation or infrared rays theory, the emitting device 12 of the major unit 10 and the receiving device 22 of the minor unit 20 are tuned into the same frequency to generate emitting and receiving functions thereby.

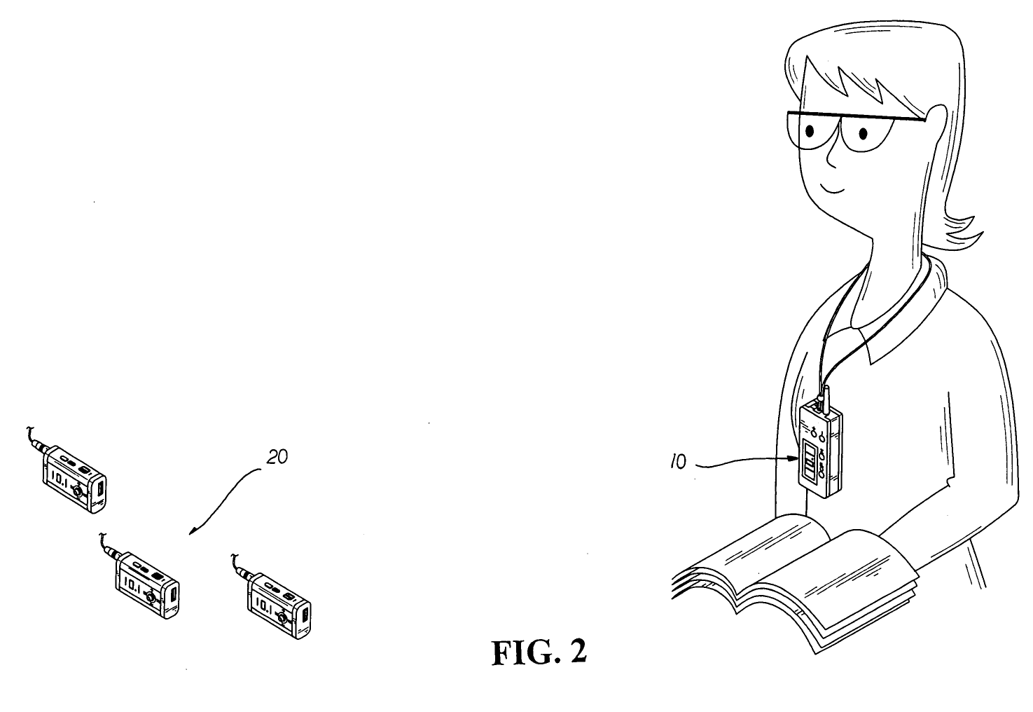

Please refer to FIG. 2 showing the application the present invention. In application, the major unit 10 functions as an emitter, while the minor unit 20 functions as a receiver, and the major and minor units 10, 20 are suitably applied to MP3 or digital recording pens. In operation, the major and minor units 10, 20 are started via the control regulating buttons 16, 26 to show the current states on the display panels 15, 25 respectively for examination and, if necessary, adjustment thereof. And, via the control regulating buttons 16, 26, the major and minor units 10, 20 are tuned into the same frequency to proceed with the operation of the emitting-and-receiving function thereby, permitting the emitting device 12 of the major unit 10 and the receiving device 22 of the minor unit 20 to form a wireless emitting-and-receiving system thereby. Therefore, when tuned into the same frequency, the major unit 10 can send out signals to be received by more than one minor unit 20. Besides, the major and minor units 10, 20 can utilize the frequency-storing devices 14, 24 to proceed with the setup of multiple sets of frequencies so that students are allowed to have certain frequencies tuned to match to those of the teachers in class. When applied in the classroom, the major unit 10 is carried by the teacher and brought to approach the sounding part of the mouth as close as possible, while the minor units 20 are respectively carried by different students each listening to the received sound via the earphones 28 connected to the earphone port 27 thereof. When the sound uttered by the teacher is obtained by the voice-receiving device 13 of the major unit 10, the sound is transmitted by the emitting device 12 with an emission wave generated thereby, and the emission wave is accepted by the receiving device 22 of each minor unit 20 before sent to the earphones 28 worn by the individual student for listening thereby. Then, the sound instantly received by the major unit 10 can be simultaneously emitted to the minor units 20, and via the minor units 20, the individual students can clearly listen to the content of the class without being influenced by the surroundings. Thus, within the permissible operating range, the emitting device 12 and the receiving device 22 thereof can reciprocally correspond to each other no matter indoors or outdoors to achieve the best state of application thereby. In addition, while receiving the sound emitted, the minor unit 20 can also have the recording device 23 switched on to start on a synchronized wireless digital recording function thereby. Thus, the content of the class can be completely recorded down words by words so that the student can repeatedly listen to it for review thereby. Furthermore, the minor unit 20 can also be equipped with the devices functioned like those of the major unit 10, providing major-to-minor-unit or minor-to-minor-unit wireless emitting-and-receiving and synchronized wireless recording functions thereby.

What is claimed is:

1. A wireless-emitting major-and-minor models recording method, comprising major and minor units wherein the major and minor units are respectively equipped with a control circuit panel built therein, and the control circuit panel of the major unit is equipped with an emitting device corresponding to a receiving device and a recording device built in the control circuit panel of the minor unit thereof, therefore, in addition to offering a wireless emitting-and-receiving function thereof, the present invention can also form a synchronized wireless digital recording effect in application.

2. The wireless-emitting major-and-minor models recording method as claimed in claim 1 wherein the control circuit panel of the major unit is equipped with a voice-receiving device and a frequency-storing device.

3. The wireless-emitting major-and-minor models recording method as claimed in claim 1 wherein the external surface of the major unit is disposed a display panel and multiple control regulating buttons respectively connected to the control circuit panel built therein.

4. The wireless-emitting major-and-minor models recording method as claimed in claim 1 wherein the control circuit panel of the minor unit is equipped with a frequency-storing device.

5. The wireless-emitting major-and-minor models recording method as claimed in claim 1 wherein the external surface of the minor unit is disposed a display panel, multiple control regulating buttons, and an earphone port respectively connected to the control circuit panel built therein.

6. The wireless-emitting major-and-minor models recording method as claimed in claim 1 wherein the minor unit is also provided with a set of earphones to fit to the earphone port thereof.

7. The wireless-emitting major-and-minor models recording method as claimed in claim 1 wherein, via the characteristics of frequency modulation or infrared ray theory thereof, the emitting device of the major unit and the receiving device of the minor unit are reciprocally tuned into the same frequency to generate emitting and receiving functions thereby.

8. The wireless-emitting major-and-minor models recording method as claimed in claim 1 wherein the major and minor units are suitably applied to MP3 and digital recording pens thereof.

9. The wireless-emitting major-and-minor models recording method as claimed in claim 1 wherein the minor unit can also be equipped with devices functioned like those of the major unit, providing major-to-minor-unit or minor-to-minor-unit wireless emitting-and-receiving and synchronized wireless recording functions thereby.
